(19) United States
(12) Patent Application Publication
(10) Pub. No.: US 2019/0045966 A1
(43) Pub. Date: Feb. 14, 2019

(54) SOAKING STRUCTURE FOR COFFEE MAKER

(71) Applicant: Ningbo Jinyu Electric Appliance Co., Ltd., Yuyao (CN)

(72) Inventors: Junda Shi, Yuyao (CN); Zhongyu Shi, Yuyao (CN); Shukuo Liu, Yuyao (CN); Hu Liu, Yuyao (CN)

(73) Assignee: Ningbo Jinyu Electric Appliance Co., Ltd., Yuyao (CN)

(21) Appl. No.: 15/705,588

(22) Filed: Sep. 15, 2017

(30) Foreign Application Priority Data
Aug. 10, 2017 (CN) 201710680764.3

(51) Int. Cl. A47J 31/18; A47J 31/06

(52) U.S. Cl. CPC A47J 31/18; A47J 31/06

(57) ABSTRACT

A soaking structure for a coffee maker, including a coffee maker funnel, a basket filter, a discharge hood and a spring clamp, a liquid inlet is formed on the top end of the funnel, and the funnel is a hollow chamber within which the basket filter is placed; a groove is formed on the bottom of the basket filter, the top of the discharge hood is located within the groove, and there is a gap between the discharge hood and the groove; a first liquid outlet is formed on the top of the discharge hood; a tail end of the discharge hood is clamped on an inner side of the liquid outlet of the coffee maker funnel; and, the spring clamp is located on the bottom of the discharge hood and clamped at a water outlet of the coffee maker funnel.

This application claims priority to Chinese application number 201710680764.3, filed Aug. 10, 2017, with a title of SOAKING STRUCTURE FOR COFFEE MAKER. The above-mentioned patent application is incorporated herein by reference in its entirety.

### TECHNICAL FIELD

The present invention relates to the technical field of coffee brewing, and in particular to a soaking structure for a coffee maker.

### BACKGROUND

Coffee makers are increasingly popular in people's daily life and provide great convenience to people's life. Nevertheless, some problems rise. For example, in an existing coffee maker, due to the short time to soak coffee raw material with hot water, it is possible that the resulting coffee solution tastes bland and thus does not satisfy users' tastes; or, since the coffee raw material is not fully mixed with hot water, the flavor of the coffee solution is decreased. In addition, after the coffee maker is used, a certain amount of residual liquid may remain in the chamber of the coffee maker. As a result, there is a risk of resulting in health hazards, and the service life of the coffee maker will be shortened due to the long-term soaking by the residual liquid.

### SUMMARY

An objective of the present invention is to provide a soaking structure for a coffee maker in order to solve the problems in the prior art. With the soaking structure, the coffee raw material in a coffee maker can be fully soaked and mixed with hot water, so that the taste of the coffee solution is improved; moreover, the presence of residual liquid in the coffee maker can be avoided, and the service life of the coffee maker is thus prolonged.

For this purpose, the present invention provides the following solutions. The present invention provides a soaking structure for a coffee maker, including a coffee maker funnel, a basket filter, a discharge hood and a spring clamp, wherein a liquid inlet is formed on the top end of the coffee maker funnel, and the coffee maker funnel is a hollow chamber within which the basket filter is placed; a groove is formed on the bottom of the basket filter, the top of the discharge hood is located within the groove, and there is a gap between the discharge hood and the groove; a first liquid outlet is formed on the top of the discharge hood; a tail end of the discharge hood is clamped on an inner side of the liquid outlet of the coffee maker funnel; and, the spring clamp is located on the bottom of the discharge hood and clamped at a water outlet of the coffee maker funnel.

Optionally, the coffee maker funnel further includes a seal cover; both the liquid inlet and the seal cover are located on the top of the coffee maker funnel, and the liquid inlet is higher than the seal cover; the seal cover is clamped on the other side of the liquid inlet through a buckle; and, the liquid inlet is used for receiving hot water flowing from a sprinkler.

Optionally, the coffee maker funnel further includes support ribs uniformly distributed on the inner side of the chamber, and the support ribs are used for supporting the basket filter and ensuring that there is a gap between the basket filter and the inner side of the chamber.

Optionally, the coffee maker funnel further includes a connecting portion and a bump which are located at the water outlet; the bump is located on the inner side of the water outlet and used for clamping with the bottom of the discharge hood; and, the connecting portion is located on the outer side of the water outlet and used for clamping with a spring of the spring clamp.

Optionally, the coffee maker funnel further includes a handle fixedly connected to the outer side of the coffee maker funnel.

Optionally, clamping ports used for clamping the basket filter with the top of the coffee maker funnel are symmetrically formed on the top of the basket filter; and, a bottom end face of the basket filter is symmetrically inclined inward and connected to the groove.

Optionally, the discharge hood is shaped like an inverted cup, and the discharge hood further includes second liquid outlets which are symmetrically formed on a bottom edge of a hood body.

Optionally, the spring clamp successively includes, from up to down, a head, a body and a round bottom; the head is located on the inner side of the water outlet, and an annular groove is formed between the head and the top of the body; the round bottom is connected to the tail end of the body and located on the outer side of the water outlet; and, one end of the spring of the spring clamp is resisted against the round bottom while the other end thereof is clamped on the outer side of the water outlet.

Optionally, a gasket is placed within the annular groove.

Optionally, the round bottom is shaped like an inverted umbrella.

Compared with the prior art, the present invention has the following technical effects.

Since the basket filter is disposed within the chamber of the coffee maker funnel and the first liquid outlet is located in a middle portion of the chamber, it is convenient to fully soak and mix coffee with hot water. According to the required number of cups of coffee, a corresponding number of coffee capsules or a corresponding amount of ground coffee is placed in the basket filter in advance, the coffee raw material will not be wasted, and the coffee raw material can be fully soaked by hot water and fully mixed with hot water. Meanwhile, the basket filter can filter impurities or coarse residues so as to improve the taste and quality of coffee.

Since the second liquid outlets are symmetrically formed on the bottom of the discharge hood, after hot water flows from the sprinkler, the mixed coffee solution will flow to the inner side of the discharge hood from the second liquid outlets. When the amount of water from the sprinkler is greater than the amount of coffee discharged from the second liquid outlets and the water level in the basket filter correspondingly rises to the first liquid outlet (in this case, the ground coffee has been soaked, and the concentration of the coffee solution is increased correspondingly), the coffee solution flows to the inner side of the discharge hood simultaneously from the first liquid outlet and the second liquid outlets and then flows into a cup through the spring clamp, wherein the first liquid outlet is a primary channel for discharging the coffee solution, and the second liquid outlets are secondary channels for preventing excessive storage of residual coffee solution. During the rise of the water level within the chamber, the coffee raw material in the basket filter can be fully soaked and mixed with hot water. Moreover, the discharge hood also has a function of temporarily storing the coffee solution.

### BRIEF DESCRIPTION OF THE DRAWING

To describe the technical solutions in the embodiments of the present invention or in the prior art more clearly, the accompanying drawings to be used in the description of the embodiments will be briefly described below. Apparently, the drawings described hereinafter are merely some of the embodiments of the present invention, and a person of ordinary skill in the art can obtain other drawings according to these drawings without paying any creative effort.

FIG. 1 is a schematic diagram of the use of a soaking structure for a coffee maker according to the present invention;

FIG. 2 is a schematic diagram of the overall disassembly of the soaking structure for a coffee maker according to the present invention;

FIG. 3 is a structural diagram of a basket filter according to the present invention;

FIG. 4 is a structural diagram of a discharge hood according to the present invention;

FIG. 5 is a structural diagram of a coffee maker funnel according to the present invention; and

FIG. 6 is a structural diagram of a spring clamp (excluding a spring) according to the present invention, in which:
1: sprinkler;
2: hot water;
3: coffee maker funnel;
31: liquid inlet;
32: seal cover;
33: handle;
34: support rib;
35: connecting portion;
36: bump;
4: basket filter;
5: discharge hood;
51: first liquid outlet;
52: second liquid outlet;
6: spring clamp;
61: head;
62: annular groove;
63: round bottom;
7: gasket;
8: spring;
9: body; and
10: clamping port.

### DETAILED DESCRIPTION

The technical solutions in the embodiments of the present invention will be clearly and completely described below with reference to the accompanying drawings in the embodiments of the present invention. Apparently, the embodiments described herein are merely part but not all of the embodiments of the present invention. All other embodiments obtained by a person of ordinary skill in the art without paying any creative effort on the basis of the embodiments in the present invention shall fall into the protection scope of the present invention.

An objective of the present invention is to provide a soaking structure for a coffee maker in order to solve the problems in the prior art. With the soaking structure, the coffee raw material in a coffee maker can be fully soaked and mixed with hot water, so that the taste of the coffee solution is improved; moreover, the presence of residual liquid in the coffee maker can be avoided, and the service life of the coffee maker is thus prolonged.

The present invention provides a soaking structure for a coffee maker, including a coffee maker funnel, a basket filter, a discharge hood and a spring clamp. The coffee maker funnel is a hollow chamber within which the basket filter is placed. A groove is formed on the bottom of the basket filter, the top of the discharge hood is located within the groove, and there is a gap between the discharge hood and the groove. A first liquid outlet is formed on the top of the discharge hood. A tail end of the discharge hood is clamped on an inner side of the liquid outlet of the coffee maker funnel. The spring clamp is located on the bottom of the discharge hood and clamped at a water outlet of the coffee maker funnel.

After hot water flows out from a sprinkler and then enters the coffee maker funnel, coffee raw material in the basket filter is soaked and mixed with hot water, and the mixed coffee solution flows out from a sidewall of the basket filter. When the water level within the chamber is higher than the first liquid outlet on the discharge hood, the coffee solution can flow out from the first liquid outlet. A drinker may place a cup under the water outlet and then push the spring clamp upward, and the coffee solution may flow into the cup. During the rise of the water level within the chamber, the coffee raw material in the basket filter can be fully soaked and mixed with hot water.

To make the objectives, features and advantages of the present invention more obvious and comprehensible, the present invention will be further described below in detail by specific implementations with reference to the accompanying drawings.

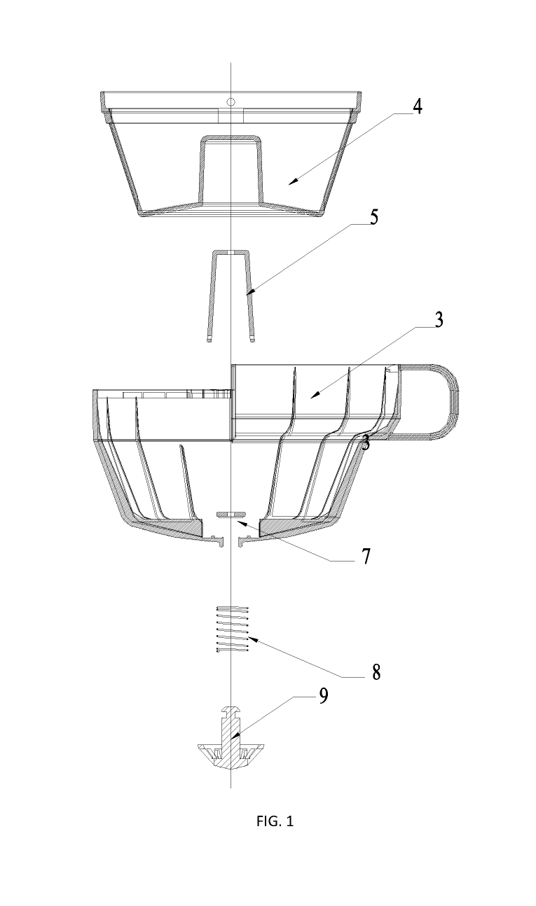

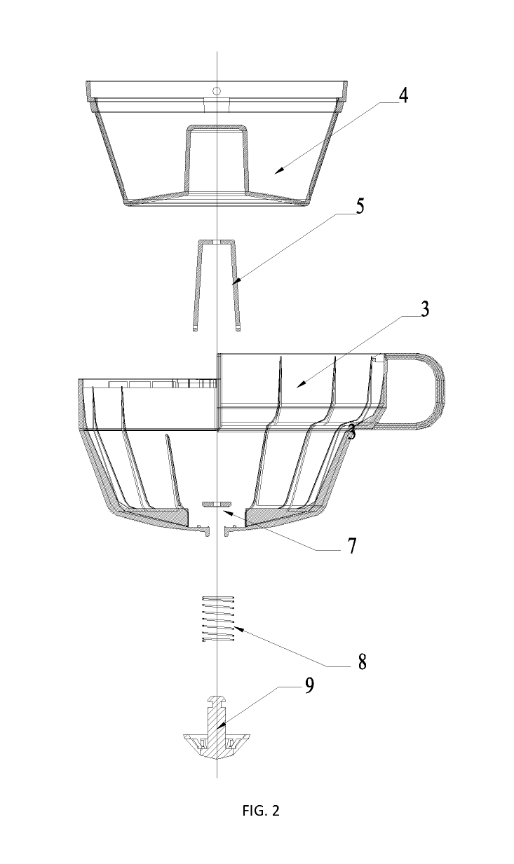

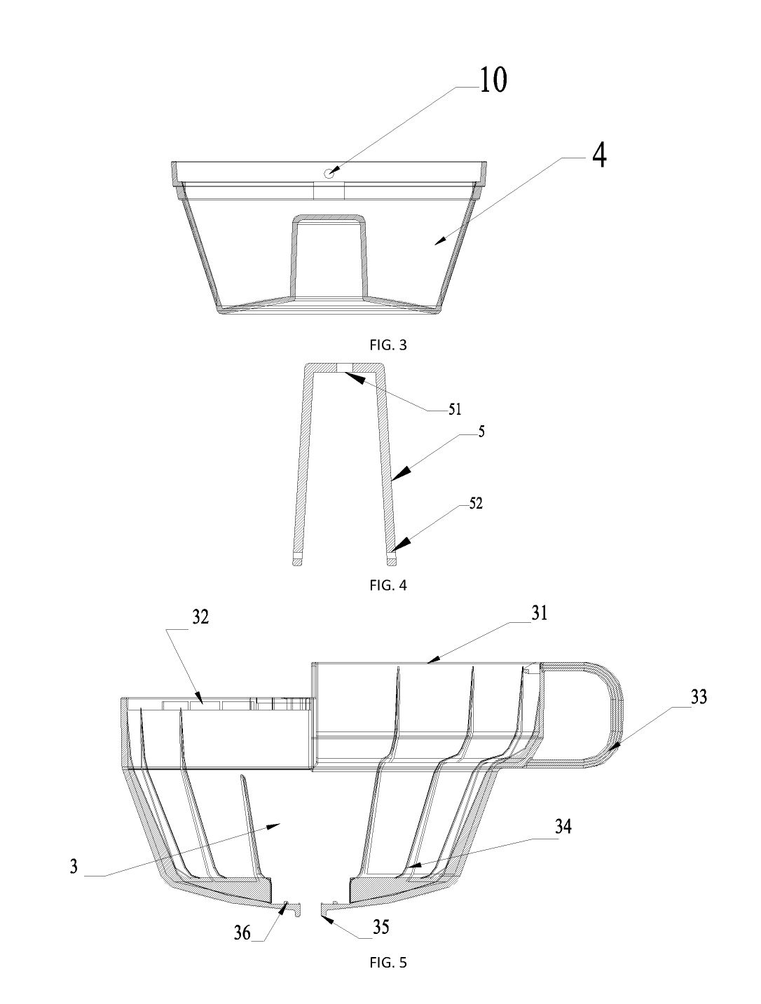

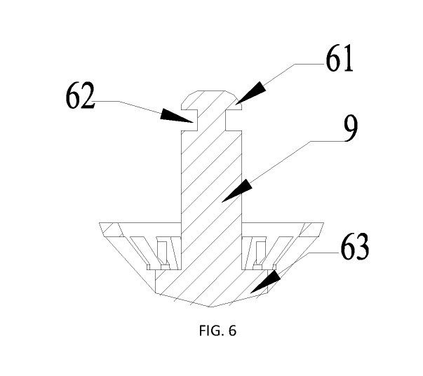

Referring to FIGS. 1 to 6, FIG. 1 is a schematic diagram of the use of the soaking structure for a coffee maker according to the present invention; FIG. 2 is a schematic diagram of the overall disassembly of the soaking structure for a coffee maker according to the present invention; FIG. 3 is a structural diagram of a basket filter according to the present invention; FIG. 4 is a structural diagram of a discharge hood according to the present invention; FIG. 5 is a structural diagram of a coffee maker funnel according to the present invention; and, FIG. 6 is a structural diagram of a spring clamp (excluding a spring) according to the present invention.

As shown in FIGS. 1 to 6, the present invention provides a soaking structure for a coffee maker, including a coffee maker funnel 3, a basket filter 4, a discharge hood 5 and a spring clamp 6. A liquid inlet 31 is formed on the top end of the coffee maker funnel 3, and the coffee maker funnel 3 is a hollow chamber within which the basket filter 4 is placed. A groove is formed on the bottom of the basket filter 4, the top of the discharge hood 5 is located within the groove, and there is a gap between the discharge hood 5 and the groove. A first liquid outlet 51 is formed on the top of the discharge hood 5. A tail end of the discharge hood 5 is clamped on an inner side of the liquid outlet of the coffee maker funnel 3. The spring clamp 6 is located on the bottom of the discharge hood 5 and clamped at a water outlet of the coffee maker funnel 3.

The coffee maker funnel 3 further includes a seal cover 32. Both the liquid inlet 31 and the seal cover 32 are located on the top of the coffee maker funnel 3, and the liquid inlet 31 is higher than the seal cover 32. The seal cover 32 is clamped on the other side of the liquid inlet 31 through a buckle. The liquid inlet 31 is used for receiving hot water flowing from a sprinkler 1. When in use, the seal cover 32 is opened first; a corresponding number of coffee capsules or a corresponding amount of ground coffee is placed in the basket filter 4; the seal cover 32 is then closed; and, the sprinkler 1 is started to allow hot water 2 to flow into the coffee maker funnel 3 from the liquid inlet 31. In addition, when the coffee maker is not in use, by opening the seal cover 32, the basket filter 4 clamped with the coffee maker funnel 3 may be taken down to clean the basket filter 4 and the coffee maker funnel 3.

The coffee maker funnel 3 further includes support ribs 34 uniformly distributed on the inner side of the chamber, and the support ribs 34 are used for supporting the basket filter 4 and ensuring that there is a gap between the basket filter 4 and the inner side of the chamber. Clamping ports 10 used for clamping the basket filter 4 with the top of the coffee maker funnel 3 are symmetrically formed on the top of the basket filter 4; and, a bottom end face of the basket filter 4 is symmetrically inclined inward and connected to the groove. The top end of the basket filter 4 is clamped onto the coffee maker funnel 3, and an outer side face of the bottom of basket filter 4 is firmly combined with the chamber of the coffee maker through the support ribs 34. During the injection of hot water 2, coffee raw material in the basket filter 4 is soaked and mixed with the hot water 2 and then can be discharged to the gap within the chamber through the sidewall of the basket filter 4. In this case, the basket filter 4 is still in an environment soaked by water. During the continuous injection of the how water 2, the water level within the chamber rises continuously (before reaching the water level at the first liquid outlet 51), and the solution within the basket filter 4 can be secondarily mixed with the solution outside the basket filter 4, so that the concentration of the coffee solution can be increased. Moreover, since the bottom end face of the basket filter 4 is symmetrically inclined inward, a large water accommodating space can be formed on the bottom of the basket filter 4, so that the water accommodating space within the chamber below the water level at the first liquid outlet 51 is increased, and the coffee solution can be mixed well.

The coffee maker funnel 3 further includes a connecting portion 35 and a bump 36 which are located at the water outlet. The bump 36 is located on the inner side of the water outlet and used for clamping with the bottom of the discharge hood 5. The connecting portion 35 is located on the outer side of the water outlet and used for clamping with a spring 8 of the spring clamp 6. A connecting groove is formed on the connecting portion 35. One end of the spring 8 is clamped within the connecting groove to fix the endpoint of the spring 8.

The coffee maker funnel 3 further includes a handle 33 fixedly connected to the outer side of the coffee maker funnel 3, so that it is convenient to take up and move the coffee maker funnel 3.

The discharge hood 5 is shaped like an inverted cup, and the discharge hood 5 further includes second liquid outlets 52 which are symmetrically formed on a bottom edge of a hood body. The first liquid outlet 51 is a primary channel for discharging the coffee solution, and the second liquid outlets 52 are secondary channels mainly used for preventing excessive storage of the residual coffee solution, so that the coffee solution at the low level within the chamber can flow out from the second liquid outlets 52.

The spring clamp 6 successively includes, from up to down, a head 61, a body 9 and a round bottom 63. The head 61 is located on the inner side of the water outlet, and an annular groove 62 is formed between the head 61 and the top of the body 9. The round bottom 63 is connected to the tail end of the body 9 and located on the outer side of the water outlet. One end of the spring 8 of the spring clamp 6 is resisted against the round bottom 63 while the other end thereof is clamped on the outer side of the water outlet. A gasket 7 is placed within the annular groove 62, and the round bottom 63 is shaped like an inverted umbrella. By providing a gasket 7 within the annular groove 62, it can be ensured that the head 61 of the spring clamp 6 is clamped within the coffee maker funnel 3, and the throttling effect can also be achieved. By designing the round bottom 63 in a shape of an inverted umbrella, a small amount of droplets at the water outlet may flow into the umbrella-shaped ring of the round bottom 63 along the body 9 of the spring clamp after the coffee cup has been taken away, so that the droplets are prevented from dropping down to form stains.

The specific use process of the soaking structure for a coffee maker of the present invention is as follows.

1. The seal cover 32 is opened first; a corresponding number of coffee capsules or a corresponding amount of ground coffee is placed in the basket filter 4; the seal cover 32 is closed; and, the sprinkler 1 is started to allow hot water 2 to flow into the coffee maker funnel 3 from the liquid inlet 31.

2. Hot water 2 flows out from the sprinkler 1 and then enters the coffee maker funnel 3. During the injection of hot water 2, coffee raw material in the basket filter 4 is soaked and mixed with the hot water 2 and then discharged to the gap within the chamber through the sidewall of the basket filter 4. In this case, the basket filter 4 is still in an environment soaked by water.

3. During the continuous injection of the how water 2, the water level within the chamber rises continuously (before reaching the water level at the first liquid outlet 51), and the solution within the basket filter 4 can be secondarily mixed with the solution outside the basket filter 4, so that the concentration of the coffee solution can be increased (since the bottom end face of the basket filter 4 is symmetrically inclined inward, a large water accommodating space can be formed on the bottom of the basket filter 4, so that the water accommodating space within the chamber below the water level at the first liquid outlet 51 is increased, and the coffee solution can be mixed well).

4. The mixed coffee solution will flow to the inner side of the discharge hood 5 from the second liquid outlets 52. When the amount of water from the sprinkler 1 is greater than the amount of coffee discharged from the second liquid outlets 52 and the water level in the basket filter 4 correspondingly rises to the first liquid outlet 51 (in this case, the ground coffee has been soaked, and the concentration of the coffee solution is increased correspondingly), the coffee solution flows to the inner side of the discharge hood simultaneously from the first liquid outlet 51 and the second liquid outlets 52.

5. A drinker may place a cup under the water outlet and then push the spring clamp 6 upward. In this case, the spring 8 is compressed, the body of the spring clamp 6 jacks up the gasket 7 and the coffee solution flows into the cup from the water outlet.

It is to be noted that, the nomination and selection of the components of the soaking structure for a coffee maker in the present invention are not limited, and the components can be described in other names or added with some common features on this basis as long as the principle is the same as the present invention; and, the other names or common features shall fall into the protection scope of the present invention.

Although the principle and implementations of the present invention have been described above by specific examples in the present invention, the foregoing description of the embodiments is merely provided for helping the understanding of the method and core idea of the present invention. Meanwhile, various alterations to the specific implementations and applications may come to a person of ordinary skill in the art according to the concepts of the present invention. In conclusion, the contents of the description shall not be regarded as limitations to the present invention.

What is claimed is:

1. A soaking structure for a coffee maker, comprising:
a coffee maker funnel, a basket filter, a discharge hood and a spring clamp; a liquid inlet is formed on the top end of the coffee maker funnel, and the coffee maker funnel is a hollow chamber within which the basket filter is placed; a groove is formed on the bottom of the basket filter, the top of the discharge hood is located within the groove, and there is a gap between the discharge hood and the groove; a first liquid outlet is formed on the top of the discharge hood; a tail end of the discharge hood is clamped on an inner side of the liquid outlet of the coffee maker funnel; and, the spring clamp is located on the bottom of the discharge hood and clamped at a water outlet of the coffee maker funnel.

2. The soaking structure for a coffee maker according to claim 1, wherein the coffee maker funnel further comprises a seal cover; both the liquid inlet and the seal cover are located on the top of the coffee maker funnel, and the liquid inlet is higher than the seal cover; the seal cover is clamped on the other side of the liquid inlet through a buckle; and, the liquid inlet is used for receiving hot water flowing from a sprinkler.

3. The soaking structure for a coffee maker according to claim 1, wherein the coffee maker funnel further comprises support ribs uniformly distributed on the inner side of the chamber, and the support ribs are used for supporting the basket filter and ensuring that there is a gap between the basket filter and the inner side of the chamber.

4. The soaking structure for a coffee maker according to claim 1, wherein the coffee maker funnel further comprises a connecting portion and a bump which are located at the water outlet; the bump is located on the inner side of the water outlet and used for clamping with the bottom of the discharge hood; and, the connecting portion is located on the outer side of the water outlet and used for clamping with a spring of the spring clamp.

5. The soaking structure for a coffee maker according to claim 1, wherein the coffee maker funnel further comprises a handle fixedly connected to the outer side of the coffee maker funnel.

6. The soaking structure for a coffee maker according to claim 1, further comprising clamping ports used for clamping the basket filter with the top of the coffee maker funnel are symmetrically formed on the top of the basket filter; and, a bottom end face of the basket filter is symmetrically inclined inward and connected to the groove.

7. The soaking structure for a coffee maker according to claim 1, wherein the discharge hood is shaped like an inverted cup, and the discharge hood further comprises second liquid outlets which are symmetrically formed on a bottom edge of a hood body.

8. The soaking structure for a coffee maker according to claim 1, wherein the spring clamp successively comprises, from top to bottom, a head, a body and a round bottom; the head is located on the inner side of the water outlet, and an annular groove is formed between the head and the top of the body; the round bottom is connected to the tail end of the body and located on the outer side of the water outlet; and, one end of the spring of the spring clamp is resisted against the round bottom while the other end thereof is clamped on the outer side of the water outlet.

9. The soaking structure for a coffee maker according to claim 8, wherein a gasket is placed within the annular groove.

10. The soaking structure for a coffee maker according to claim 8, wherein the round bottom is shaped like an inverted umbrella.
